(19) United States
(12) Patent Application Publication
(10) Pub. No.: US 2012/0281410 A1
(43) Pub. Date: Nov. 8, 2012

(54) Illuminating Device and Structure with Illuminating Device

(75) Inventor: Wai Kwok Wong, Kowloon (HK)

(73) Assignee: TRAXON TECHNOLOGIES LTD., Shatin (HK)

(21) Appl. No.: 13/508,626

(22) PCT Filed: Dec. 8, 2010
(86) PCT No.: PCT/CN10/79569

§ 371 Date: Jul. 20, 2012

(30) Foreign Application Priority Data
Dec. 8, 2009 (DE) 10 2009 057 443.3

(51) Int. Cl. F21V 21/00

(52) U.S. Cl. 362/249.02

(57) ABSTRACT

An illuminating device includes an illuminator with an illuminating mechanism. The illuminating mechanism includes several LEDs. The illuminating device is reversibly fixed by at least one holding device. The holding device includes a guiding device and a wing shaped unit. The wing shaped unit can be fixed and turned on the guiding device and can be guided along the guiding device. The holding device includes an unfolding mechanism. The wing shaped unit is oriented transverse to the guiding device by arranging the unfolding mechanism. The wing shaped unit is completely unfolded at a light emitting side. When the wing shaped unit is guided away from the light emitting side, the wing shaped unit is reversibly folded via a physical contact with a folding mechanism. The span of the light emitting side is greater than the span with the wing shaped unit being folded.

This patent application is a national phase filing under section 371 of PCT/CN2010/079569, filed Dec. 8, 2010, which claims the priority of German patent application 10 2009 057 443.3, filed Dec. 8, 2009, each of which is incorporated herein by reference in its entirety.

### TECHNICAL FIELD

The present invention relates to an illuminating device, and in addition to an arrangement with the same.

### SUMMARY OF THE INVENTION

In one aspect of the invention a type of reversibly assembled illuminating device is specified.

According to at least one embodiment of the illuminating device, the illuminating device comprises an illuminator having a light emitting side and a top side opposite to the light emitting side. The light generated by the illuminating device during operation will mainly or eventually pass through the light emitting side and exit from the illuminating device. In this case, the light emitting side is flat, particularly is a fictitious surface. This particularly fictitious surface is obtained as follows. The side of the illuminator opposite to the top side, from which the majority of light moves out of the illuminator, has an outside annular seamed edge. Through this seamed edge that is one dimension and closed, a plane is defined by taking an average. A portion of the plane is light emitting side, which portion is located within a boundary of the projection of the side of the illuminator opposite to the top side on the plane. The light emitting side can be the same as an actual light emerging surface. Therefore, the actual light emerging surface may be formed as a plane, or may also be constructed or curved into a convexity.

There is at least one illuminating mechanism in the illuminator. The illuminating mechanism is thus provided to generate visible light during operation of the illuminating device. It is particularly preferable that the illuminating mechanism is based on opto-electronic semiconductor components, such as light-emitting diodes and/or laser diodes, or includes a plurality of such opto-electronic semiconductor components, or consists of a plurality of such opto-electronic semiconductor components.

According to at least one embodiment of the illuminating device, the illuminating device includes one or preferably a plurality of reversibly operated holding devices for fixing the illuminating device. In this case, “reversibly” means that the illuminating device may be assembled or disassembled by means of the holding device many times without being damaged. The illuminating device is, for example, a ceiling light, wherein the illuminating device may, for example, be fixed on or in a top inside a space through at least one holding device. Through releasing the holding device, the illuminating device may, for example, be removed again from the top without being damaged, and in particular may be directly re-assembled in a condition that no component is replaced or no other structure is changed. The illuminating device is a build-in illuminating device, for example.

According to at least one embodiment of the illuminating device, the holding device includes at least one guiding device. The guiding device is, for example, a guideway, a screw rod, a grate bar, a smooth tube and/or a bowden control. The longitudinal axis of the guiding device is oriented transverse to the light emitting side of the illuminator. Particularly, the longitudinal axis of the guiding device is oriented perpendicular to the light emitting side, for example, with a maximum tolerance of 10° or 5°.

According to at least one embodiment of the illuminating device, the holding device includes a wing shaped unit directly or indirectly fixed on the guiding device. Further, the wing shaped unit is mounted such that the wing shaped unit is turnable in a plane transverse to the light emitting side. Particularly, the wing shaped unit is turnable in the plane perpendicular to the light emitting side and in particular radially relative to the illuminator. In addition, the wing shaped unit may be guided along the guiding device. In other words, the wing shaped unit can be positioned along the guiding device rightly, particularly can also be oriented reversibly, wherein the wing shaped unit is maintained in mechanical connection with the illuminator.

According to at least one embodiment of the illuminating device, the holding device includes a unfolding mechanism, through which the wing shaped unit may be oriented transverse to the longitudinal axis of the guiding device, and in particular, toward a direction away from the illuminator. The unfolding mechanism is formed, for example, from a spring, which is permanently fixed on the wing shaped unit and permanently applies a spring force on the wing shaped unit, such that the wing shaped unit is under a force orienting the wing shaped unit in the direction away from the illuminator. Therefore, the unfolding mechanism may be formed from a prestressed spring.

According to at least one embodiment of the illuminating device, the holding device further includes a folding mechanism located on a side of the wing shaped unit opposite to the light emitting side. In other words, the folding mechanism is further away from the illuminator than the wing shaped unit. Specifically the end of the wing shaped unit is opposite to the illuminator and/or the guiding device. The folding mechanism is preferably in direct or indirect mechanical connection with the guiding device and/or the illuminator. The folding mechanism is preferably a rigid, unmovable means in use according to regulations. Therefore, the folding mechanism is maintained within a fixed, specified or predetermined distance from the illuminator and/or the light emitting side. The distance between the folding mechanism and the wing shaped unit is variable.

According to at least one embodiment of the illuminating device, the wing shaped unit is unfolded completely through the unfolding mechanism at or near the light emitting side. At or near the light emitting side may mean that, in this region, the wing shaped unit is not in direct mechanical contact with the folding means. Near the light emitting side may also mean that the distance between the light emitting side and the closest point of the wing shaped unit on the guiding device is smaller than 1.5 times the length of the wing shaped unit.

“Turn” means that the wing shaped unit is movable in a plane transverse to the light emitting side, wherein a turning angle between the guiding device and the wing shaped unit facing toward the light emitting side is associated with the position of the wing shaped unit along the guideway through a continuous function, and the turning angle is preferably between 0° (including 0°) and 90°. Therefore, no abrupt change occurs in the tuning angle when the wing shaped unit is moving along the guiding device.

According to at least one embodiment of the illuminating device, a region in which the wing shaped unit is unfolded, is defined by a geometric configuration of the folding mechanism. For example, the wing shaped unit is unfolded, in particular, fully unfolded, along the guiding device in a region that is not covered by the folding mechanism in a direction perpendicular to the longitudinal axis of the guiding device, and that, for example, with a tolerance of 60% of the thickness of the wing shaped unit.

According to at least one embodiment of the illuminating device, the wing shaped unit is reversibly folded up through the folding mechanism, thereby the wing shaped unit is movable along the guiding device toward the direction away from the light emitting side. Then, when mechanically contacted with the folding mechanism, the wing shaped unit is continuously folded up particularly as the distance between the hinge on the wing shaped unit and the light emitting side increases. When being moved away from the folding mechanism or the top side of the illuminator, i.e., being guided toward the light emitting side, the wing shaped unit is reversibly unfolded again. “Reversibly” means that the folding and unfolding may be repeated many times without damage when the holding device is used in accordance with regulations.

According to at least one embodiment of the illuminating device, the light emitting side has a basic span larger than a span of the illuminating device with the wing shaped unit being folded. The basic span is, for example, a diameter of the light emitting side defined in a plane perpendicular to the light emitting side, wherein at least one wing shaped unit or at least one of the wing shaped units is presented in the plane. In other words, with the wing shaped unit being folded up, the illuminator may be guided through the hole to the light emitting side or a brim formed on the light emitting side. Through subsequent unfolding of the wing shaped unit, the illuminating device may then be fixed in the hole, due to fact that the span with the wing shaped unit being unfolded is larger than the span with the wing shaped unit being folded up. The spans with the wing shaped unit being in a folded state and in an unfolded state particularly and respectively are the maximum distance between portions of the two different wing shaped units that are opposing to each other on the illuminator, wherein the portions are most far away from the illuminator. The basic span and the span of the wing shaped unit are preferably determined in the same direction.

In at least one embodiment of the illuminating device, the illuminating device comprises an illuminator having a light emitting side and a top side opposite to the light emitting side. At least one illuminating mechanism is provided inside the illuminator. The illuminating device is reversibly fixed through at least one holding device. In this case, the holding device has a guiding device oriented transverse to the light emitting side and a wing shaped unit fixed on the guiding device. The wing shaped unit can be turned in a direction transverse to the light emitting side and can be guided along the guiding device. Further, the holding device includes an unfolding mechanism arranged such that the wing shaped unit is oriented transverse to the guiding device, and in particular is permanently oriented in a direction away from the illuminator. A folding mechanism of the holding device is located on the guiding device and on a side of the wing shaped unit opposite to the light emitting side. When being guided away from the light emitting side, the wing shaped unit is reversibly folded up through mechanical contact with the folding mechanism. In addition, the light emitting side has a basic span larger than a span with the wing shaped unit being folded.

With this configuration of the holding device, the illuminating device is allowed to be reversibly, i.e., repeatedly, and simply mounted and dismantled without damage.

Due to improved efficiency and power of LEDs (light-emitting diodes), the LEDs are increasingly used in illuminating devices, for example, for residential lighting and architectural lighting, and in particular in ceiling lights. Based on increased power consumption of the LEDs, sufficient cooling for LEDs must be ensured. This is achieved through, for example, a cooling body and/or heat sink consisting of a metal, such as aluminum, for example. At least one cooling body and/or at least one power supply of the illuminating device, for example, respectively have a weight of at least 1 kg, at least 1.5 kg or at least 2 kg.

The weight of the illuminating device is increased particularly due to the cooling body or the power supply as well, and this increased weight can be a few kilograms, for example, between 2 kg (including 2 kg) and 8 kg. Due to this relatively large weight, a simple spring mechanism for assembling a halogen lamp or a fluorescent lamp cannot be used in such an illuminating device having LEDs. Particularly, it is necessary for the holding device to be suitable for the illuminating device with larger weight, so as to reliably ensure sufficient assembly security and to meet requirements of provisions. Since the holding device has to receive a relatively high force and thus is constructed solidly, an irreversible holding device may cause damage to, for example, the top or the illuminating device itself during dismantling or during assembling of the illuminating device based on a relatively high force as required.

According to at least one embodiment of the illuminating device, the guiding device is rotatably mounted. Through rotating of the guiding device, particularly rotating around the longitudinal axis of the guiding device, the wing shaped unit is movable reversibly, i.e., bidirectionally, along a longitudinal direction, and the position of the wing shaped unit along the longitudinal direction can be determined.

According to at least one embodiment of the illuminating device, at least one holding device is reversibly fixed on the illuminator. In other words, the guiding device may be removed from the illuminator without damaging the holding device or the illuminator, and also may be re-fixed onto the illuminator again. Thus, for example, a modification of a conventional illuminating device having one or more holding device is possible.

According to at least one embodiment of the illuminating device, an average diameter of the light emitting side is larger than an average diameter of the top side of the illuminator. Particularly, in the projection of the top side in the plane of the light emitting side, the stripe of the light emitting side encloses the top side completely. In other words, as viewed in the projection, an edge or brim enclosing the top side is formed by the light emitting side. As viewed in the projection, the edge or brim may completely enclose the top side.

According to at least one embodiment of the illuminating device, the wing shaped unit is provided for absorbing a force of at least 10N, particularly a force of at least 15N or a force of at least 40N, in a direction perpendicular to the light emitting side. In other words, when being used in accordance with regulations under one of the forces, with such a high force acted permanently, other portions of the wing shaped unit, the guiding device or the holding device are not damaged.

According to at least one embodiment of the illuminating device, the wing shaped unit has at least one raised portion, preferably on an end opposite to the guiding device. The raised portion is particularly a protrusion, which extends away from a main plane of the wing shaped unit and toward the light emitting side in an unfolded state. The raised portion is formed in, for example, a ridge-like shape. Through the raised portion, reducing the contact area on the assembling plate may be achieved. It is possible that the raised portion is embedded into the material of the assembling plate and thus friction between the wing shaped unit and the assembling plate is increased.

In addition, an arrangement having at least one illuminating device according to one or more of the above described embodiments is provided. Therefore, the features for the illuminating device also disclose features for the arrangement, and vice versa.

According to at least one embodiment of the arrangement, the illuminating device is fitted in a hole in an assembling plate of, for example, a shell, a suspended ceiling or a top plate, i.e., particularly to facilitate top assembly. The assembling plate particularly refers to an assembling plate having a thickness smaller than an extension of the illuminator as measured from the light emitting side to the top side. In other words, the illuminator then completely passes through the hole.

According to at least one embodiment of the arrangement, the light emitting side and at least one wing shaped unit are located on different sides of the assembling plate that are opposite one another. Further, as measured from a middle axis of the illuminator until an end of the wing shaped unit in an unfolded state opposite to the illuminator, the radius of the hole on the assembling plate, into which the illuminating device is fitted, is smaller than half of the basic span of the light emitting side, and is larger than or equal to the span with the wing shaped unit being folded.

According to at least one embodiment of the arrangement, the illuminating device is mechanically and reversibly fixed to the assembling plate by pressing the at least one wing shaped unit. In other words, the assembling plate is fixedly clamped by means of the brim or the annular edge on the light emitting side and by means of the at least one wing shaped unit.

The illuminating device described herein may be used as a radiator or lamp for general illumination and/or architectural lighting. The illuminating device is particularly designed for assembling into a ceiling, a wall and/or a floor of a building and/or facility object.

### BRIEF DESCRIPTION OF THE DRAWINGS

The illuminating device and the arrangement illustrated herein will be described in detail by way of exemplary embodiments with reference to the drawings. Wherein, like reference number indicates like element in various figures, which are not drawn to scale herein, but instead, may present the various elements exaggerated for better understanding.

FIGS. 1A to 1C and 2A to 2H show schematic views of embodiments of the illuminating device and the arrangement illustrated herein;

FIGS. 3A to 3F and 6A to 6B show schematic views of embodiments of the holding device illustrated herein;

FIGS. 4A and 4B show schematic views of the wing shaped unit illustrated herein; and

FIG. 5 shows a schematic view of the unfolding mechanism illustrated herein.

### DETAILED DESCRIPTION OF ILLUSTRATIVE EMBODIMENTS

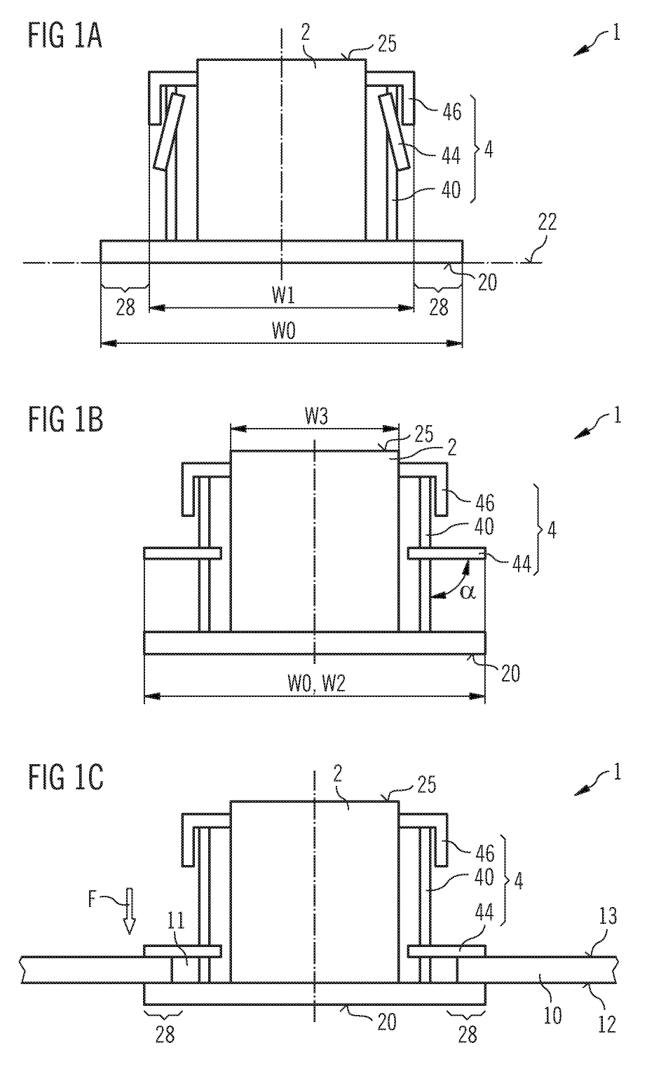

In FIGS. 1A through 1C, an exemplary embodiment of illuminating device 1 and the construction thereof are shown in schematic side views. The illuminating device 1 has an illuminator 2 having a top side 25 and a bottom side opposite to the top side 25 as a light emitting side 20. A plane 22 is defined by the light emitting side 20.

Further, the illuminating device 1 has two holding devices 4. Each of the holding devices 4 includes a guiding device 40 along which a wing shaped unit 44 may be guided in a direction perpendicular to the plane 22. Further, each of the holding devices 4 has a folding mechanism 46 and an unfolding mechanism not shown in FIG. 1. The folding mechanism 46 is fitted on the illuminator 2 in proximity to the top side 25.

Each of the entire holding devices 4 is entirely mounted on an interface of a lateral surface of the illuminator 2 and does not protrude out of the top side 25 in the direction away from the plane 22. The holding devices 4 with the wing shaped units 44 being folded have a span W1 smaller than a basic span W0 of the light emitting side 20 of the illuminating device 1, as shown in FIG. 1A.

Like the illuminator 2 itself, the top side 25 and the light emitting side 20 are, for example, respectively formed rotationally symmetry, particularly in circular shape. In this case, an average diameter W3 (FIG. 1B) of the top side 25 is smaller than the basic span W0. An annular edge 28 encloses around the top side 25 and the holding device 4 as viewed in the projection on the plane 22.

According to FIG. 1A, the wing shaped units 44 are in mechanical contact with the folding mechanism 46. Thus, the wing shaped units 44 are folded. According to FIG. 1B, the wing shaped units 44 are unfolded with a maximum angle α of 92.5°, particularly a maximum angle α of 90°, between the guiding device 40 and the wing shaped unit 44 toward the light emitting side 20.

According to FIG. 1B, a span W2 with the wing shaped units 44 being unfolded is equal to the basic span W0 of the light emitting side 20. The guiding device 40 are oriented perpendicular to the light emitting side 20, for example, with a maximum tolerance of 10° or 5°. The wing shaped units 44 are oriented parallel to the light emitting side 20 with a maximum tolerance of 10° or 5°, and thus are configured into a plane.

In FIG. 1C, it shows how the illuminating device 1 is installed on the assembling plate 10 in a schematic side view. The assembling plate 10 has a hole 11, through which the illuminating device 1 can be inserted together with the folded wing shaped units 44 from a front side 12 of the assembling plate 10, as shown in FIG. 1A. Next, the wing shaped units 44 are unfolded by guiding the wing shaped units 44 toward the light emitting side 20 along the guiding device 40, as shown in FIG. 1B, and are continuously moved toward a back side 13 of the assembling plate 10. Finally, the assembling plate 10 is clamped through the annular edge 28 or brim on the light emitting side 20 and the wing shaped units 44, which results in a force F. The force F applied on each of the wing shaped units 44 is, for example, larger than 20N, or larger than 30N, and is directed parallel to gravity.

Unlike what is shown in FIG. 1, it is possible that the illuminating device 1 has more than two holding devices 4, such as three or four holding devices 4. In a plane parallel to the light emitting side 20, the holding devices 4 are preferably mounted along the illuminator 2 at equal intervals. It is possible that the illuminating device 1 is provided with only one of the holding devices 4 that has a movable wing shaped unit and, for example, a further rigid means in hook-shaped not shown in the figures, particularly in the circumstances that the assembling plate 10 has a predetermined thickness.

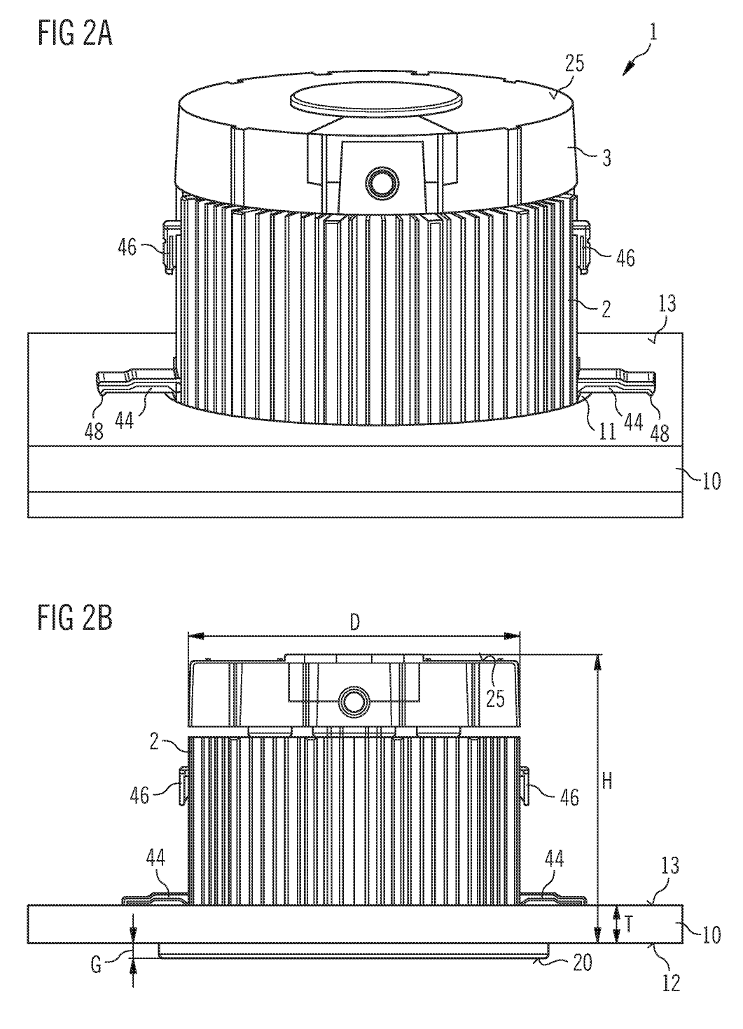

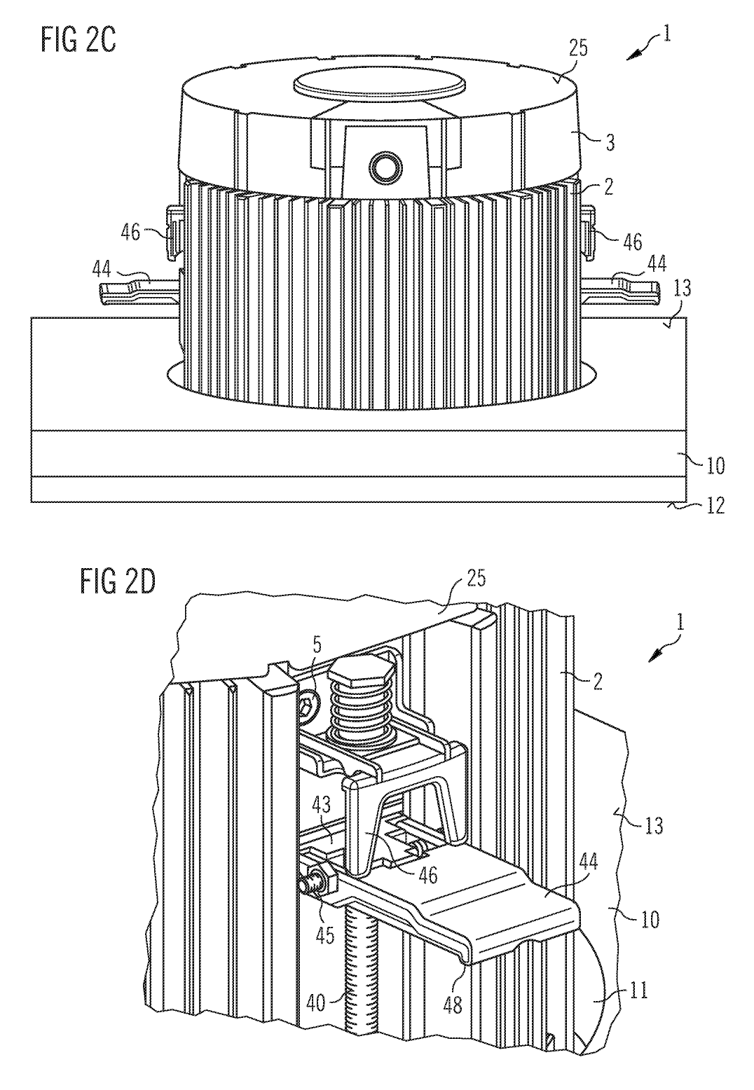

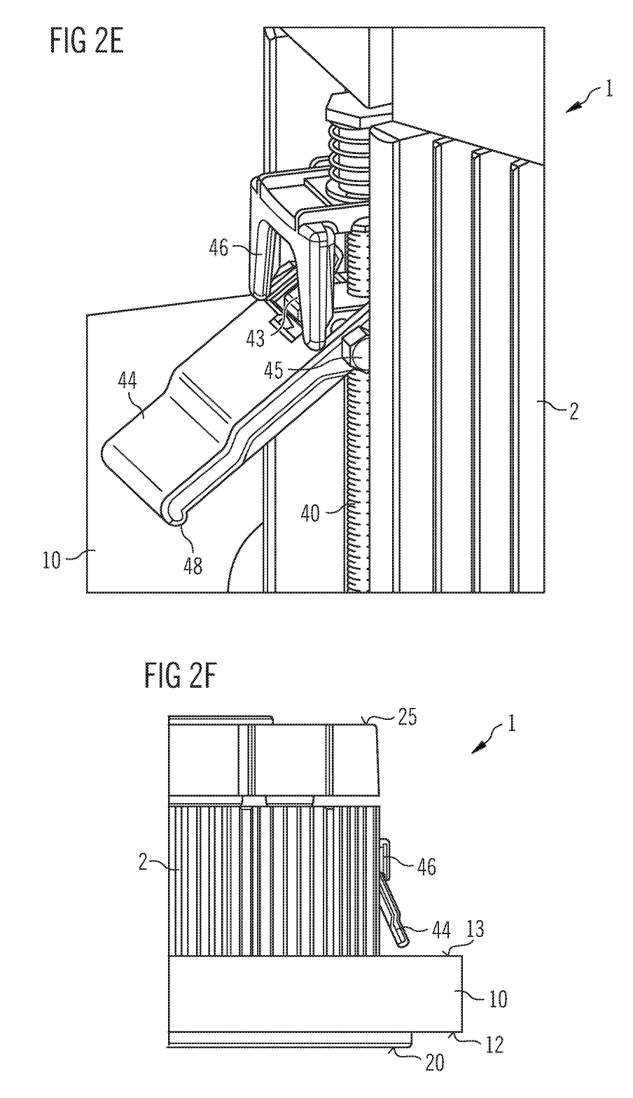

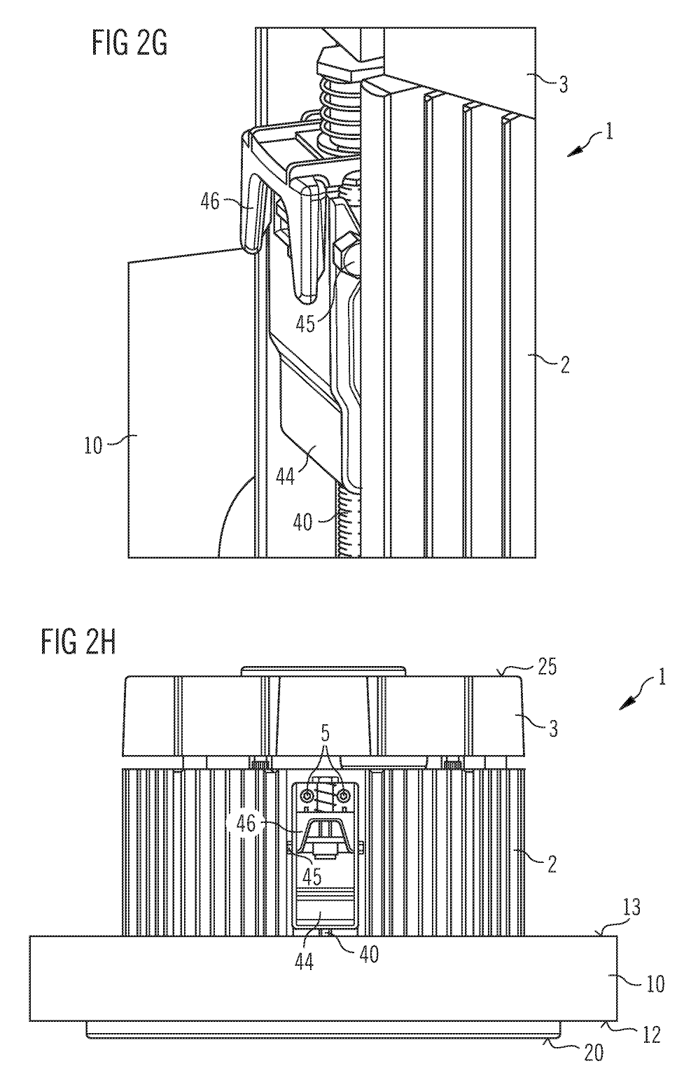

In FIG. 2A, shows another exemplary embodiment of the illuminating device 1 in a holding state as in FIG. 1C in a perspective view, also refer to the side view in FIG. 2B. The illuminator 2 is provided with cooling ribs, and/or includes a cooling body not shown in the figures, and further includes a power supply 3 that closes the illuminator 2 in the direction away from the assembling plate 10. The holding devices 4 are mounted laterally on the illuminator 2 within the region where the cooling ribs are arranged. The entire illuminating device 1 has a weight, for example, between 1 kg (including 1 kg) and 10 kg, particularly between 1.25 kg (including 1.25 kg) and 5 kg, more particularly about 2.4 kg.

An average diameter D (FIG. 2B) of the illuminating device 1 at the top side 25 is, for example, between 100 mm (including 100 mm) and 400 mm, particularly between 125 mm (including 125 mm) and 300 mm, more particularly about 170 mm. The illuminating device 1 has a height H, as measured from the front side 12 of the assembling plate 10 to the top side 25, of for example between 60 mm (including 60 mm) and 250 mm, particularly between 90 mm (including 90 mm) and 200 mm, more particularly 145 mm. The overrun portion of the illuminator 2 from the light emitting side 20 to the front side 12 of the assembling plate 10 has a length of, for example, between 1 mm (including 1 mm) and 20 mm, preferably between 4 mm (including 4 mm) and 12 mm, more particularly 7 mm. The illuminating device 1 is driven by AD current having a voltage of about 220V to 240V, and has an electric power consumption larger than 15 W, particularly larger than 25 W, for example, about 30 W.

Also, as can be seen from FIG. 2A, with an irreversible holding device 4, the illuminating device 1 cannot be removed from the assembling plate 10 without damaging or destroying the assembling plate 10 or the wing shaped units 44.

In FIGS. 2C, 2D, 2E and 2G, the illuminating device 1 are shown in 3D views focused on the holding devices 4. FIG. 2C is a 3D view similar to FIG. 1B with the wing shaped unit 44 unfolded. According to FIG. 2D in which the holding device 4 is shown in more detail, the wing shaped unit 44 is still fully turned up and thus is properly brought into mechanical contact with the folding mechanism 46.

In the embodiment of the illuminating device 1 according to FIG. 2, the guiding device 40 are respectively formed from a screw rod having a metric thread M5, or a thread with high pitch that is two or three times larger than the thread M5.

Through rotating of the guiding device 40 about an axis perpendicular to the light emitting side 20, the wing shaped unit 44 and a wing shaped unit holding means 43 may be guided along the guiding device 40. The wing shaped unit 44 is prevented from rotating about a longitudinal axis parallel to the guiding device 40 through the wing shaped unit holding means 43 that is located in a protrusion within the cooling ribs of the illuminator 2 and preferably includes an inner screw, through which the inner screw of the guiding device extends. Further, the wing shaped unit 44 is connected with the wing shaped unit holding means 43 through a hinge 45.

The hinge 45 is, for example, formed from a steel bolt having a diameter of about 3 mm and a length of about 30 mm to 60 mm. With this hinge 45, a shearing force of about 9.5 kN is needed to achieve a displacement or bend of the bolt by 0.1 mm. If material with higher rigidity, such as high quality steel, is used, improved stability can be achieved.

In addition, the guiding device 40 passes through the folding mechanism 46, and is rotatably mounted inside the folding mechanism 46. The folding mechanism 46 is formed from a curved piece, which curved piece is reversibly fixed on the illuminator 2 via a fastener 5 formed from a screw. The rigid and unmovable folding mechanism 46 has a region configured in U-shape, which region is spaced apart from the guiding device 40 in a direction parallel to the light emitting side 20 and is further away from the illuminator 2 than the guiding device 40. This region of the folding mechanism 46 is directed from the top side 25 toward the light emitting side 20 not shown in FIG. 2D.

According to FIG. 2E and the side view of FIG. 2F, the wing shaped unit 44 is partially folded up. The folding happens through moving the wing shaped unit holding means 43 toward the direction away from the assembling plate 10 by rotating of the guiding device 40. Through mechanical contact with the folding mechanism 46, a force is applied on the wing shaped unit 44 such that the wing shaped unit is turned up on the hinge 45. Herein, the wing shaped unit holding means 43 itself does not experience the turning movement. In other words, a spring force of the unfolding mechanism 42 permanently acting on the wing shaped unit 44 is overcome through the rigid folding mechanism 46. Therefore, a stress from a spring of the unfolding mechanism 42 is not eliminated during folding, but is permanently maintained, wherein the spring force acting on the wing shaped unit 44 may even be increased.

In addition, as can be seen from FIG. 2E, the wing shaped unit 44 has a raised portion 48 on its end away from the guiding device 40, by means of which raised portion 48, the illuminating device 1 may be fixed onto the assembling plate 10 with a larger adhesive force.

The holding device 4 with the wing shaped unit 44 being completely folded up can be seen in FIG. 2G, also referring to the side view of FIG. 2H. In this position, the wing shaped unit 44 is disposed parallel to the guiding device 40. Further, the wing shaped unit 44 is, in particular, completely concealed within a heat sink of the illuminator 2. The position where the wing shaped unit 44 is located in a folded state is provided by the geometric configuration of the folding mechanism 46. When the wing shaped unit 44 is in the folded state, the illuminating device 1 may be removed from or inserted into the hole 11 of the assembling plate 10 with ease.

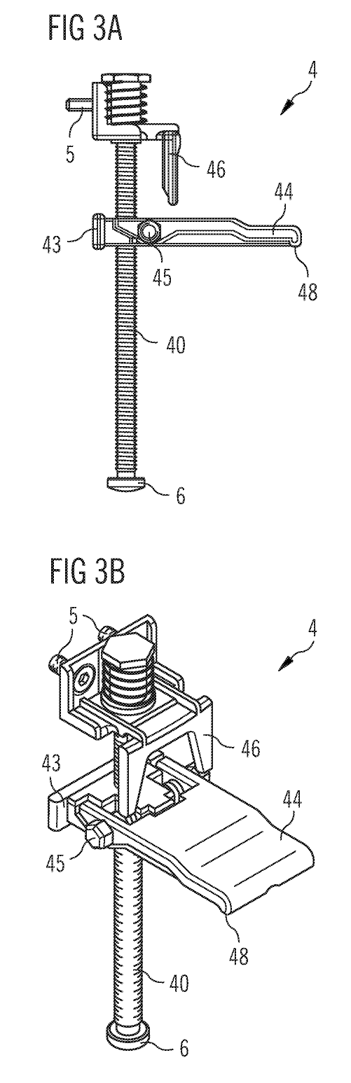

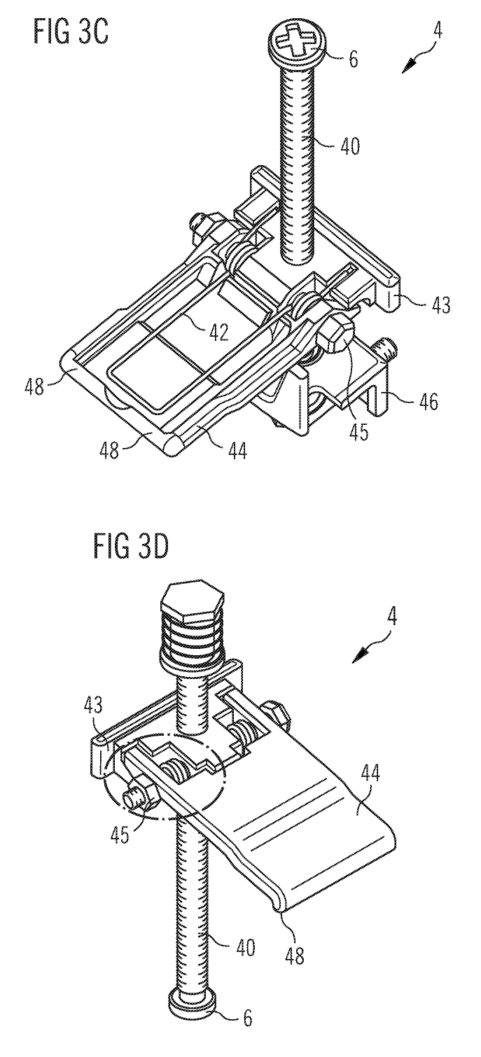

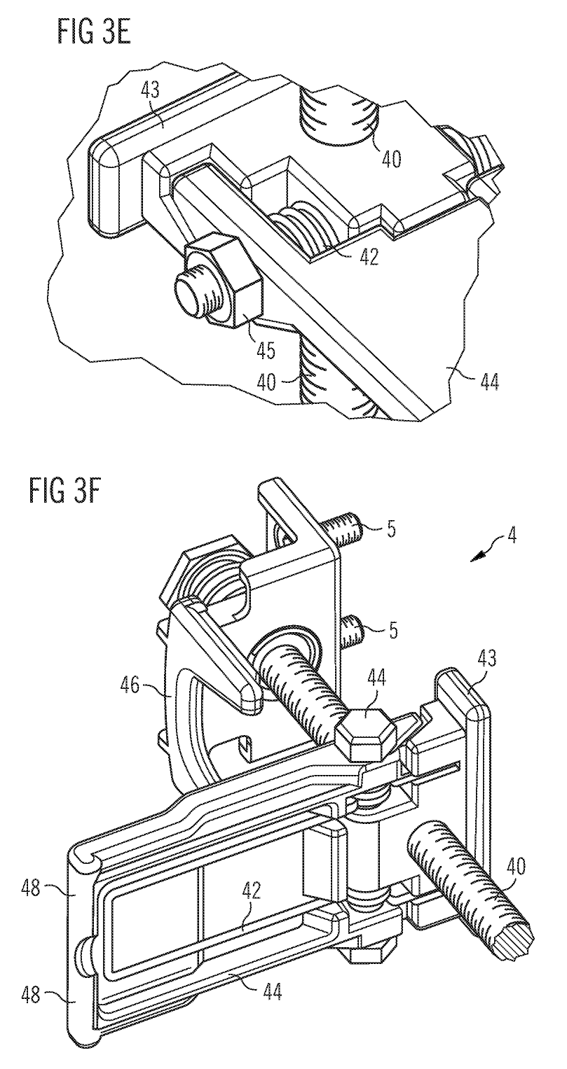

The holding device 4 is shown in more detail in the side view according to FIG. 3A and the 3D views according to FIG. 3B through FIG. 3F. In this case, FIG. 3E is an enlarged view of the portion indicated in FIG. 3D.

On a side opposite to the folding mechanism 46, the guiding device 40 has a clamp 6, which clamp 6 is formed from a receiving portion for an ordinary screw driver or inner hexagonal spanner, for example. The clamp 6 includes a so-called Philips-Kopf, for example. Through the clamp 6, the guiding device 40 may be caused to rotate, and through this rotation, the position of the wing shaped unit 44 along the guiding device 40 is reversibly adjusted by means of the wing shaped unit holding means 43 and the hinge 45. “Reversibly” means that the wing shaped unit 44 may move toward or away from the light emitting side 20 alternately. Therefore, with the clamp 6, the wing shaped unit 44 is reversibly pressed or clamped onto the assembling plate 10.

Regardless of the length of the wing shaped unit 44 and the thickness T of the assembling plate 10, the length L of the guiding device 40 is, for example, between 40 mm (including 40 mm) and 150 mm, and particularly about 95 mm.

The unfolding mechanism is formed from a spring configured in U-shape and prestressed, also referring to FIG. 5. The unfolding mechanism 42 is fixed on the wing shaped unit holding means 43 through a hinge 45. The hinge 45 may be formed from a screw having a diameter of about 3 mm and a length of about 25 mm, which screw is locked through a nut.

The spring forming the unfolding mechanism 42, referring to FIG. 5, may present the following characteristic parameters with a corresponding tolerance having a maximum coefficient of 2 or 1.5, for example. Specifically, the thickness d of the wire forming the spring may be 0.8 mm, the winding diameter C thereof may be 4 mm, the length r of the spring may be 31 mm. The spring may have four coils, and the elastic modulus may be about 209 Gp. Then, the spring force applied on the wing shaped unit 44 particularly is at least 0.05N or at least 0.1N. For example, the spring force is smaller than 2N or smaller than 0.5N.

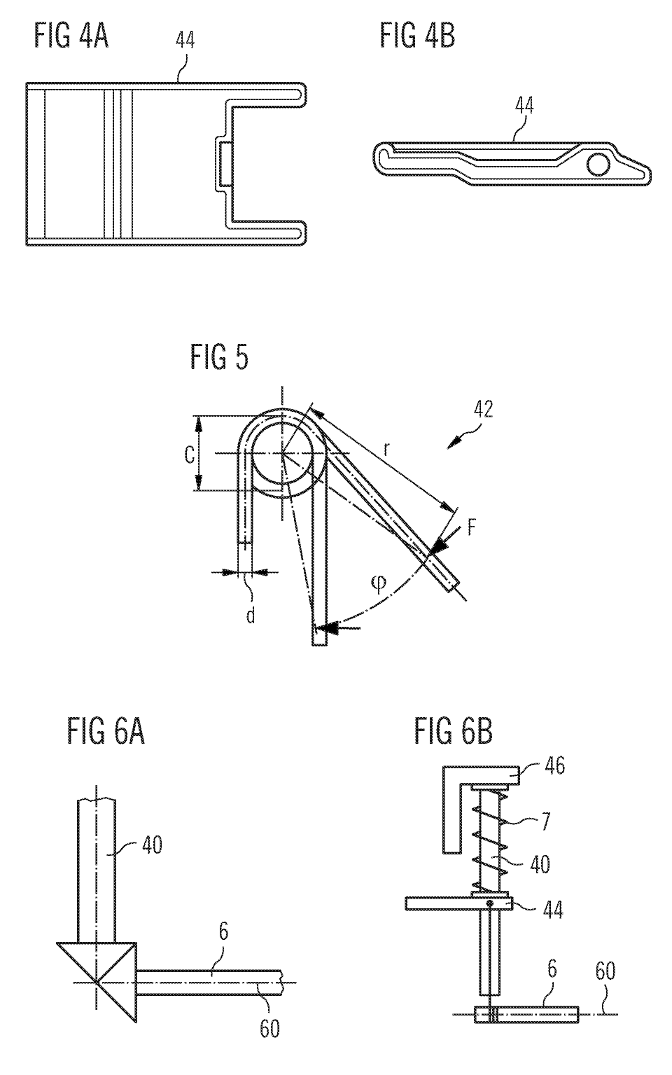

A top view of the wing shaped unit 44 is shown in FIG. 4A, and a side view of the wing shaped unit 44 is shown in FIG. 4B. The wing shaped unit 44 has an overall length of, for example, about 42 mm, and an overall width of, for example, about 23 mm. The wing shaped unit 44 has a thickness of, for example, about 6 mm in the region of the hinge 45 not shown in FIG. 4, and a thickness of, for example, about 4 mm at the end where the raised portion 48 not shown in FIG. 4B is presented. With a planar wing shaped unit 44, a more evenly distributed pressure on the assembling plate 10 is achieved.

The possibility to implement turning of the guiding device 40 is shown in FIG. 6A. The clamp 6 having a rotating axis 60 and the guiding device 40 have conical heads which may have structures engaged to each other. Therefore, the rotating axis 60 of the clamp 6 is capable of turning 90° relative to the rotating axis of the guiding device 40. Thus, the rotating axis 60 is oriented transversely to the guiding device 40. Therefore, it is possible that the illuminating device 1 does not need a hole for the clamp 6 to turn downwardly. Such a clamp can also optionally be provided in other exemplary embodiments.

According to FIG. 6B, an optional spring 7 is provided between the wing shaped unit 44 and the folding mechanism 46, which spring pulls the wing shaped unit 44 toward the folding mechanism 46. The movement of the wing shaped unit 44 toward the direction away from the folding mechanism 46 is made by using preferably a lockable bowden control. The bowden control may particularly be operated through the clamp 6, which clamp has the rotating axis 60 oriented, for example, parallel to the light emitting side 20 not shown in FIG. 6. Preferably, the guiding device 40 is a smooth tube or a grate bar.

The invention described herein is not limited to the description by way of the exemplary embodiments. In contrast, the present invention includes any of the new features or any combination of the features, particularly each of the features and the combinations thereof defined in the claims, even the feature or the combination itself is not specifically illustrated in the claims or the exemplary embodiment.

1. An illuminating device comprising:
an illuminator having a light emitting side and a top side opposite to the light emitting side;
an illuminating mechanism comprising light-emitting diodes and positioned within the illuminator; and
a reversibly operated holding device fixing the illuminating device, wherein the holding device comprises:
a guiding device oriented transverse to the light emitting side;
a wing shaped unit fixed on the guiding device, wherein the wing shaped unit can be turned in a direction transverse to the light emitting side and can be guided along the guiding device;
an unfolding mechanism arranged such that the wing shaped unit is oriented transverse to the guiding device and toward a direction away from the illuminator; and
a folding mechanism located on the guiding device and on a side of the wing shaped unit (44) opposite to the light emitting side, wherein the wing shaped unit can be unfolded completely over the light emitting side, and the wing shaped unit is reversibly folded up through mechanically contacting with the folding mechanism when being guided away from the light emitting side, and wherein the light emitting side has a basic span larger than a span with the wing shaped unit being folded.

2. The illuminating device according to claim 1, wherein the folding mechanism is unmovable and rigid.

3. The illuminating device according to claim 1, wherein the folding mechanism is fixedly connected with the guiding device directly or indirectly, wherein the folding mechanism comprises a curved piece located on a side of the guiding device opposite to the illuminator, and wherein the curved piece is spaced apart from the guiding device and extends from the top side toward the light emitting side.

4. The illuminating device according to claim 1, wherein the guiding device comprises a device selected from the group consisting of a screw rod, a grate bar, a smooth tube, a bowden control, and a spring.

5. The illuminating device according to claim 1, wherein the guiding device is rotatably mounted and wherein through rotation of the guiding device, the wing shaped unit can be reversibly moved and fixed along the guiding device.

6. The illuminating device according to claim 1, wherein through rotating of a clamp or a part of a clamp about an axis transverse to the guiding device, the position of the wing shaped unit along the guiding device can be moved or fixed.

7. The illuminating device according to claim 1, wherein the holding device is reversibly fixed on the illuminator, and wherein the illuminating device is a ceiling light.

8. The illuminating device according to claim 1, wherein an average diameter of the light emitting side is larger than an average diameter of the top side, and wherein, in a projection of the top side on the light emitting side, the light emitting side encloses the top side completely and an annular edge is formed.

9. The illuminating device according to claim 1, wherein the unfolding mechanism comprises or is a spring, wherein a force applied on the wing shaped unit by the unfolding mechanism is smaller than that applied on the wing shaped unit by the folding mechanism.

10. The illuminating device according to claim 1, wherein the wing shaped unit is formed in a plate shape and has at least one raised portion on an end opposite to the guiding device, in an unfolded state of the wing shaped unit, the at least one raised portion is directed toward a plane in which the light emitting side lies.

11. The illuminating device according to claim 1, wherein the guiding device is arranged perpendicular to the light emitting side, and the wing shaped unit over the light emitting side is positioned parallel to the light emitting side and perpendicular to gravity.

12. The illuminating device according to claim 1, wherein the wing shaped unit together with a wing shaped unit holder are fixed on the guiding device through a hinge, wherein the hinge and the wing shaped unit holder define an angle between the wing shaped unit and the guiding device toward the light emitting side at a maximum of 92.5°.

13. The illuminating device according to claim 1, wherein the illuminator and/or a power supply has a weight of at least 1 kg, and, in the illuminating device, the wing shaped unit is provided for absorbing a force of at least 15N in a direction perpendicular to the light emitting side.

14. The illuminating device according to claim 1, wherein the illuminating device comprises one to four holding devices.

15. An arrangement having at least one illuminating device according to claim 1, in which the illuminating device is fitted in a hole defined in an assembling plate, wherein:
the light emitting side and at least one wing shaped unit are located on different sides of the assembling plate that are opposite with one another;
a diameter of the hole is smaller than the basic span (W0) of the light emitting side, and is larger than or equal to the span with the wing shaped unit being folded; and
the illuminating device is mechanically and reversibly fixed to the assembling plate by pressing the at least one wing shaped unit.

16. The illuminating device-according to claim 1, wherein the illuminating device is a ceiling light.

17. The illuminating device-according to claim 1, further comprising a power supply adjacent the top side of the illuminator.

18. The illuminating device-according to claim 17, wherein the illuminating device has a weight between 1.25 kg and 5 kg.

19. An illuminating device comprising:
an illuminator having a light emitting side and a top side opposite to the light emitting side;
an illuminating mechanism comprising light-emitting diodes and positioned within the illuminator; and
a reversibly operated holding device fixing the illuminating device, wherein the holding device comprises:
a guiding device oriented transverse to the light emitting side;
a wing shaped unit fixed on the guiding device, wherein the wing shaped unit can be turned in a direction transverse to the light emitting side and can be guided along the guiding device;
an unfolding means arranged such that the wing shaped unit is oriented transverse to the guiding device and toward a direction away from the illuminator; and
a folding means located on the guiding device and on a side of the wing shaped unit opposite to the light emitting side, wherein the wing shaped unit can be unfolded completely over the light emitting side, and the wing shaped unit is reversibly folded up through mechanically contacting with the folding means when being guided away from the light emitting side, and wherein the light emitting side has a basic span larger than a span with the wing shaped unit being folded.
